(19) United States
(12) Patent Application Publication
(10) Pub. No.: US 2002/0091641 A1
(43) Pub. Date: Jul. 11, 2002

(54) Method for user-related billing for transmitted television, video, radio or games programs in a restricted-access system, and a system for carrying out the method

(76) Inventor: Gero Offer, Gilching (DE)

Correspondence Address: BELL, BOYD & LLOYD, LLC, P. O. BOX 1135, CHICAGO, IL, 60690-1135, US

(21) Appl. No.: 10/006,908

(22) Filed: Nov. 7, 2001

(30) Foreign Application Priority Data
Nov. 8, 2000 (DE) 100 55 243.9

(51) Int. Cl. G06F 17/60; H04L 9/00

(52) U.S. Cl. 705/52; 705/1

(57) ABSTRACT

A method and system for user-related billing for transmitted television, video, radio or games programs in a restricted-access system, which includes the steps of transferring an amount of money to a credit account which is associated with usage identification, comparing entered and storage usage identification data, debiting an amount of money which is associated with a desired television, video, radio or games program, and allocating and transmitting a key for decoding the usage identification and the desired television, video, radio or games program.

### BACKGROUND OF THE MENTION

Pay TV is known as a form of television which transmits pay television programs as requested by a user, at a time predetermined by the user, via a specific television channel and in a specific sequence. One subgroup of pay TV is what is referred to as pay-per-view, in which the user pays only for those television programs which he/she also actually sees. This means that billing is based, for example, on minutes, quarter-hour periods in which viewing occurs, or transmissions of the television program that are viewed. Thus, in contrast to classical pay TV, in which a fixed monthly amount is paid for a specific channel, the pay-per-view system requires that payment be made only for the television programs which the user actually watches in a specific time.

It is furthermore known for conditional access systems to be used in pay TV systems, in order to ensure that pay TV programs (television programs) can be received only by the users who are authorized to do so. This is done by encrypting the program contents by storing receiving rights in a security module in a control device in a terminal which is connected between the actual television set and an antenna device for receiving the program contents, and by adding reception conditions for the actual program content.

Such terminal control devices for controlling reception of television programs are generally set-top boxes or decoders. However, other terminals are also possible; for example, PC cards or PC-MCIA modules. The terminal with a control device also can be integrated in a television. Such terminal control devices carry out functions such as decompression, decoding, digital/analog conversion, reception, enabling and billing for the program contents. In order to encrypt such program contents and to handle associated billing, the user normally buys a smart card, and pushes it into the terminal control device in order to use it. Such a smart card enables a television channel which contains the desired television program, once a specific amount has been paid by the user. Since such smart cards can be used interchangeably in a terminal control device, it is possible to transfer the smart card to someone else. Billing for television program contents can, thus, be transferred to another user, by transferring the smart card once it has been enabled. The billing of program contents to an individual person, therefore, is not essential.

In the case of a “virtual card,” the data are managed and maintained centrally by a server. There are no card readers or similar hardware in the set-top box.

Since payments for prepaid TV systems are based on time units which pass while watching television programs, it is desirable that the billing for television program contents which are watched be carried out flexibly and quickly in order to avoid interrupting a film if the prepaid time interval is shorter than the total time of the film. This risk occurs, in particular, when a previously enabled smart card has a fixed associated amount which does not correspond to the total amount required for the entire film. In this case, it would first of all be necessary to find an institution to re-enable the smart card in order to be able to watch the desired film all the way through.

The present invention is, therefore, directed toward providing a method for user-related billing for transmitted television programs in a restricted-access system, and a restricted-access system for carrying out this method, which allows user-related, flexible and fast billing for pay television programs, together with fast user-friendly user identification for the permitted access to specific television programs.

### SUMMARY OF THE INVENTION

A major aspect of the present invention is that a virtual card is used in the terminal control device, rather than a previously used smart card, in order to control and to allow fast, uncomplicated, user-specific billing for the television programs to be transmitted and for user-specific access to the television programs. By using such a virtual card, when the terminal control device is first switched on, a telecommunications connection is set up to a central service provider, also referred to as a server, and the number and authorization levels of the required usage identifications are automatically checked by the user. The user then uses a normal bank connection or states his/her credit card number to transfer a specific amount of money, which is assigned to his/her usage identification, and which is then reduced by the service provider on the basis of the selected television programs by a charge corresponding to the selected television program (individual program, specialist-services channels, monthly fee, etc.; i.e., pay-per-view. The service provider debits an amount of money only once a step of comparison of the usage identification data entered by the user with usage identification data stored in the service provider indicates that an authorized user is accessing the restricted-access system.

In addition, such debiting also takes place only when the specific user has sufficient credit in his/her own credit account to cover the amount of money appropriate for the desired television program; that is, the amount of money is sufficient for the desired television program. The user can thus receive a television program which he/she would like to watch only if the user has previously deposited in the credit account allocated to the user a sufficient amount of money for the television program he/she wishes to watch, and the user identifies himself/herself as the authorized user via the usage identification to be entered. User-related flexible billing for the transmitted television program is thus possible.

A step of checking whether or not the credit account has sufficient credit for the desired television program makes it possible to use the control device to indicate to the user that he/she will first of all have to transfer a larger amount of money to his/her credit account before reception of the desired television program is possible. If the user now uses, for example, online banking to rapidly transfer this amount of money to the credit account assigned to him/her, then it is possible for the user to have rapid access to a television program that he/she would like to watch in a simple manner, and, in consequence, rapid billing for the television program to be transmitted is possible.

In addition, the service provider checks whether access to the desired television program for the user with that specific usage identification is possible at all. If this is not the case, for example in the case of films which must not be watched by users younger than 18 years old, then a decoding key for usage identification and the desired television program is not allocated, and the program provider does not transmit this decoding key to the control device. It is thus possible to prevent or allow access to specific television programs on a user-related basis.

According to one embodiment of the present invention, the credit account can be subdivided into various credit sub-accounts, in order in this way to allow access to the prepaid TV system on a personal basis for an entire family. Shopping credit accounts also can be set up.

It is also feasible to enter the identification number for an item from a transmitted shopping program, rather than a desired television, video, radio or games program. In this case, the various steps of checking, for example that there is sufficient credit in the credit account or comparison of the entered and stored usage identification data, are carried out in the same way in order then to send to the user an item which has been seen and ordered in the shopping program, rather than sending a desired television program to the user. To do this, it is also necessary to state a postal address for delivery of the item to the user. This likewise can be done during the initialization of the account.

The system according to the present invention advantageously has devices for storing a user profile, which includes the usage identification data, and for storing a television program and television channel program, which includes the available television programs, and a comparison device for comparing usage identification data stored and entered by the user, as well as television program data stored and entered by the user. This allows user-related allocation of a specific key for decoding the desired television programs to be transmitted. Other users, therefore, cannot access a specific range of television programs, which is available only to this user.

Additional features and advantages of the present invention are described in, and will be apparent from, the following Detailed Description of the Invention and the Figures.

### BRIEF DESCRIPTION OF THE FIGURES

FIG. 1 shows a schematic illustration of one embodiment of the restricted-access system of the present invention with user-related billing for transmitted shopping programs.

FIG. 2a shows a first part of a flowchart for one embodiment of the method according to the present invention.

FIG. 2b shows a second part of a flowchart for the one embodiment of the method according to the present invention.

### DETAILED DESCRIPTION OF THE INVENTION

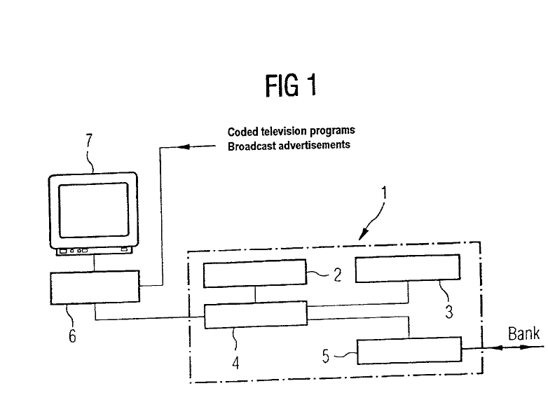

FIG. 1 shows one embodiment of the restricted-access system of the present invention with user-related billing for transmitted television programs. In this case, the system includes a service provider 1 and a control device 6 (set-top box) arranged at the receiving end, and a television set 7 arranged at the receiving end. The control device 6 is connected between the television set 7 and an antenna device (which is not shown in this illustration) for receiving coded television programs, films and/or shopping programs.

The service provider 1 contains a memory device 2, which contains a user-specific profile which represents the usage identification data. These usage identification data are compared in a comparison device 4 with the entered usage identification data, such as the data entered by the user via the control device 6, in order to check that these data items are or are not identical. If the compared usage identification data items are identical, a specific amount of money is then debited from a credit account 5, corresponding to a television program which the user wishes to watch and which he/she previously has entered in the control device 6.

A memory device 3 contains a television program and a television channel profile which, inter alia, reflects the available television programs. If the desired television program entered by the user matches a television program contained in the memory device 3, the appropriate amount of money is debited from the account 5, provided the usage identification data are identical.

Once the amount of money has been debited successfully from the credit account 5, a decoding key is allocated to the usage identification data and to the desired television program, which is then transmitted to the control device 6, where the coded television program to be transmitted can be decoded.

Before any comparison of the usage identification data and of the television program data and debiting of amounts of money take place, the user is requested via the control device 6 to enter an amount of money in his/her credit account. This is done using an entirely normal bank connection, which is connected to the account 5. Alternatively, a credit card number can be stated, so that the service provider 1 can debit the user's credit card account rather than debiting the account 5.

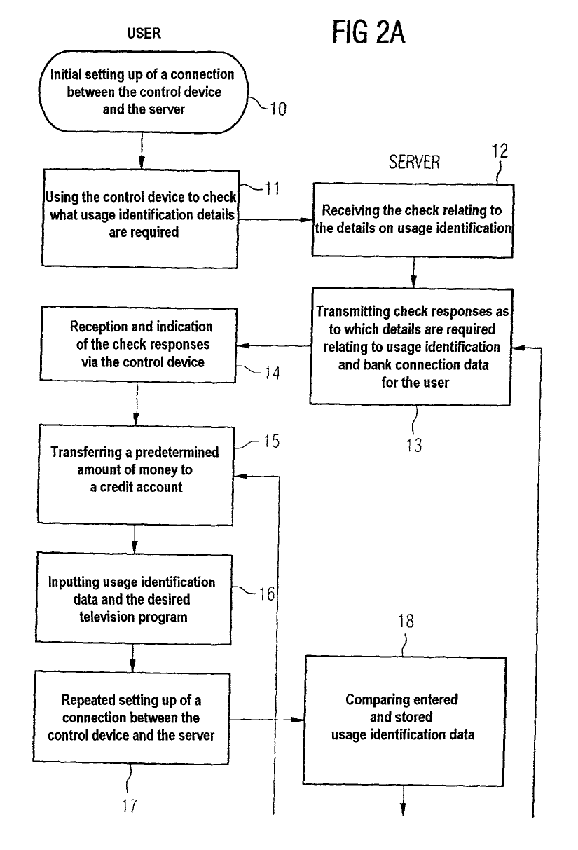

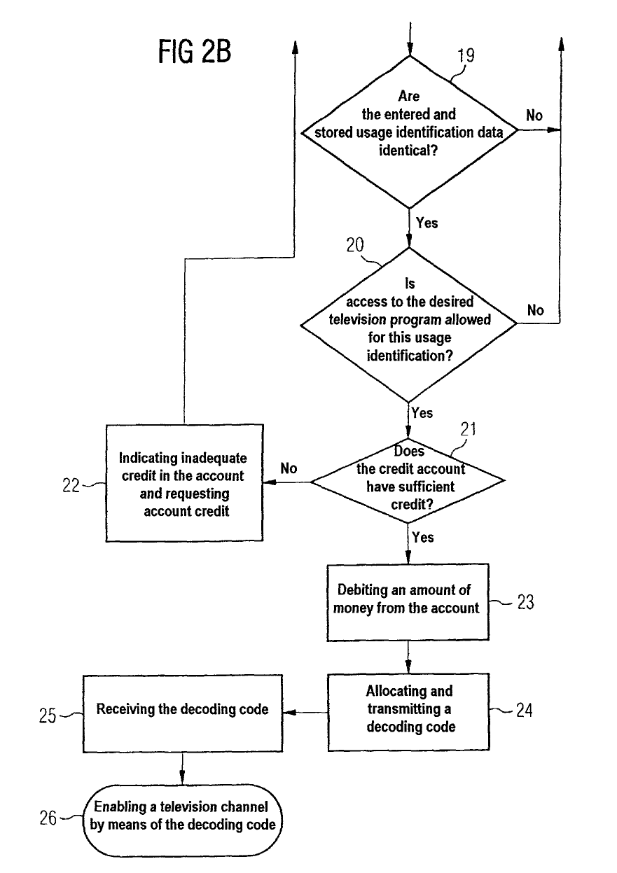

One embodiment of the method according to the present invention for user-related billing for transmitted television programs in a restricted-access system will now be explained in more detail with reference to FIGS. 2a and 2b. When a user obtains a terminal control device (set-top box) in order to allow reception of pay television programs, he/she is also given a virtual card. This virtual card has a printed ID and access PIN so that, once a connection has been set up to the service provider, the appropriate account/profile is actuated via inputs on, for example, the remote control/keys on the set-top box (step 10). At the same time, the control device 6 carries out a check of which details are required from the usage identification. This relates in particular to details about the number and authorization levels for user identification (step 11). In a step 12, the service provider 1 receives the check relating to the details about the usage identification and, via the control device 6, sends the user the relevant details (in steps 13 and 14) about the usage identification and about the user's bank connection data to be stated.

Then, in a step 15, the user transfers a predetermined amount of money, the amount of which should correspond at least to the amount of money required for the television program which he/she would like to watch, via a normal bank connection to a credit account which is allocated to the user's usage identification.

The user then enters the usage identification data and information about the desired television program into the control device, in a step 16. This input and the previously carried-out check of the usage identification data and of the information about the desired television program are carried out, for example, using a remote control and software which is arranged locally in the control device 6. The usage identification data includes a user identifier (user ID) and a personal identification number (PIN).

The software which is arranged locally in the control device now once again sets up a connection to the service provider (step 17) which then compares the entered usage identification data with the usage identification data stored in the memory device 2 to see if they are identical (steps 18 and 19). As soon as it is found that the user identification data items are identical, a check is carried out in a step 20 to determine whether the user has the stated usage identification data for access to the desired television program. If this is not the case, for example because he/she is not yet 18 years old, then the process passes back to a loop to the step 13 in the same way as if the check of the usage identification data found that the data items were not identical. The service provider then once again sends the check responses to the control device, in order to inform the user of the details of the usage identification and user's bank connection data which are required.

As soon as access to the desired television program is affirmed in step 20, a check is carried out in step 21 to determine whether or not the existing credit account has sufficient credit for the desired television program. If the amount of credit in the credit account is not sufficient for the desired television program, the control device is used, in step 22, to indicate to the user that he/she must first of all ensure that there is sufficient credit in the account by once again transferring an amount of money to the associated credit account, as is carried out in step 15.

If the credit account has sufficient credit, the service provider automatically debits an amount of money associated with that television program from the credit account, in step 23. The specific decoding key is then allocated to the usage identification and to the desired television program in step 24, and is sent to the control device, which receives the required decoding key in step 25, so that the user then uses this key to decode a coded television channel with the desired television program and thus makes it possible to access the pay television program (step 26). This enabling process results in the desired television program being received in the television set 7.

Although the present invention has been described with reference to specific embodiments, those of skill in the art will recognize that changes may be made thereto without departing from the spirit and scope of the invention as set forth in the hereafter appended claims.

1. A method for user-related billing for transmitted programs in a restricted-access system, the programs selected from the group consisting of television, video, radio and games programs, the method comprising the steps of:
providing a transmitting device for transmitting at least one desired program;
providing a service provider for releasing the at least one desired program to be transmitted;
providing a control device arranged at a receiving end for controlling access to pay programs;
providing a television set for receiving the at least one desired program;
setting up a telecommunications connection between the control device and the service provider;
requesting, via the service provider, that an amount of money be transferred to a credit account and that both usage identification data and the at least one desired program be entered in the control device;
transferring the amount of money to the credit account associated with the usage identification data with the service provider;
entering the usage identification data in the control device;
transmitting the usage identification data to the service provider;
comparing the entered usage identification data with stored usage identification data;
debiting an amount of money associated with the at least one desired program when the entered usage identification data and the stored usage identification date are identical;
allocating a key for decoding both the usage identification data and the at least one desired program;
transmitting the key to the control device; and
enabling a television channel with the at least one desired program, via the control device, to allow the television set to receive the at least one desired program.

2. A method for user-related billing for transmitted programs in a restricted-access system as claimed in claim 1, the method further comprising the step of:
checking, via the service provider, whether the credit account has sufficient credit to charge for the at least one desired program.

3. A method for user-related billing for transmitted programs in a restricted-access system as claimed in claim 2, the method further comprising the steps of:
indicating on the control device that there is no credit in the credit account; and
requesting that an amount of money be transferred to the credit account if the credit account does not have sufficient credit.

4. A method for user-related billing for transmitted programs in a restricted-access system as claimed in claim 1, the method further comprising the step of:
checking whether the entered usage identification data has an associated access capability to the at least one desired program.

5. A method for user-related billing for transmitted programs in a restricted-access system as claimed in claim 1, wherein the usage identification data includes a user identifier and a personal identification number.

6. A method for user-related billing for transmitted programs in a restricted-access system as claimed in claim 1, wherein the step of requesting further includes the steps of using a remote control and software in the control device to check what user identification data are required and which programs are being offered.

7. A restricted-access system with user-related billing for transmitted programs, the programs selected from the group consisting of television, video, radio and games programs, comprising:
a transmitting device for transmitting at least one desired program;
a service provider for releasing the at least one desired program to be transmitted;
a control device arranged at a receiving end for controlling access to pay programs;
a television set for receiving the at least one desired program;
a telecommunication connection between the control device and the service provider;
a device for crediting and debiting an amount of money to and from, respectively, a credit account associated with user identification data with the service provider;
a device for storing a user profile which contains the user identification data;
a device for storing a program and a television channel profile containing available programs;
a comparison device for comparing usage identification data entered by the user and the stored usage identification data;
a device for allocating a key for decoding the usage identification data; and
a device for transmitting and receiving data which are transmitted between the service provider and the control device.

8. A restricted-access system with user-related billing for transmitted programs as claimed in claim 7, further comprising:
a checking and input device for checking required detail relating to the usage identification data and to the programs, and for entering the usage identification data and the at least one desired program.

9. A restricted-access system with user-related billing for transmitted programs as claimed in claim 7, further comprising:
a checking and input device including a remote control and software which is stored in the control device.

10. A restricted-access system with user-related billing for transmitted programs as claimed in claim 7, wherein the control device is arranged between the television set and an antenna device which receives the programs.
